(19) United States
(12) Patent Application Publication
(10) Pub. No.: US 2007/0176062 A1
(43) Pub. Date: Aug. 2, 2007

(54) Lifting anchor support

(75) Inventors: Robert Urquhart Connell, Victoria (AU); Barry William Crone, Balwyn (AU)

Correspondence Address: LOWE, HAUPTMAN, GILMAN & BERNER, LLP (ITW), 1700 DIAGONAL ROAD, SUITE 300, ALEXANDRIA, VA, 22314, US

(73) Assignee: ITW CONSTRUCTION PRODUCTS AUSTRALIA PTY LTD, Victoria (AU)

(21) Appl. No.: 11/564,629

(22) Filed: Nov. 29, 2006

(30) Foreign Application Priority Data
Nov. 30, 2005 (AU) 2005906706

(51) Int. Cl. F16M 11/00; A47G 23/02

(52) U.S. Cl. 248/153; 248/175

(57) ABSTRACT

A support stand for a lifting anchor to be incorporated into a concrete component during casting thereof is formed from two identical components of bent wire assembled together to form an upper support frame and legs projecting downwardly from the frame. The two components are connected by only two welds, each at one of two zones of intersection of the two components.

### BACKGROUND OF THE INVENTION

1. Field of the Invention

The present invention relates to a support for setting a cast-in lifting anchor into a concrete component.

2. Description of the Prior Art

Conventionally, concrete components such as beams, panels, and slabs which require to be lifted during erection will incorporate lifting anchors to provide lifting points for the component, the anchors being incorporated into the component at the time of casting. For slabs or panels which are cast on-site for erection by a face-lift tilt-up lifting action for movement between a flat or horizontal orientation in which the component is cast to a vertical orientation, the lifting anchors, known as face-lift anchors, are supported from the bed on which the component is cast. The head of the anchor is received within a void former which will lie adjacent to the upper surface of the cast component so that when the void former is removed after casting the head of the lifting anchor will lie within the void thus formed for attachment to appropriate lifting equipment. One prior form of support for holding the anchor and void former during casting for this purpose is in the form of a wire stand which engages with the void former attached to the head of the anchor and has projecting legs which extend downwardly beyond the foot of the anchor to rest on the casting bed and hold the foot of the anchor above the bed. These prior forms of support stand usually consist of an upper ring which surrounds and engages the void former and several legs connected to the ring by welding and projecting downwardly from the ring. For stability the legs are each bent into a relatively complex shape so that the legs meet or intersect in a lower part of the structure where they are tied together, before extending outwardly into foot portions which rest on the bed.

### SUMMARY OF THE INVENTION

The present invention seeks to simplify the design of such support stands by reducing the number of component parts and thereby reducing the number of welding operations needed in assembly.

According to the present invention there is provided a support stand for a void former and lifting anchor assembly to be cast into a concrete component, the support stand being formed from two components of bent wire which, when assembled together, define an upper frame from which the void former can be supported with the body of the anchor being suspended beneath the void former and legs projecting downwardly from the frame to rest on a bed on which the component is cast.

Advantageously, the two wire components are connected by just two welds each at one of two zones of intersection of the two components.

Advantageously, the two components are of identical shape. It is also advantageous for the number of bends in each component to be kept to a minimum.

Further according to the invention, there is provided a support stand for an anchor to be cast into a concrete component, the support stand being formed from two identical components of bent wire welded together to form an open upper frame from which the anchor is supported and legs projecting downwardly from the frame to rest on a bed on which the concrete component is cast.

### BRIEF DESCRIPTION OF THIE DRAWINGS

Embodiments of the invention will now be described by way of example only with reference to the accompanying drawings in which:

FIG. 1 is a perspective view showing a support stand in accordance with an embodiment of the invention and showing also a void former and lifting anchor assembly carried by the stand by cooperation between an upper frame within the stand and the void former;

FIG. 2 is a side view of the stand shown in FIG. 1;

FIG. 3 is a perspective view of the stand shown in FIG. 1;

FIG. 4 is a perspective view of one of the two identical bent wire components used for assembling the stand;

FIG. 5 is a side view equivalent to FIG. 4;

FIGS. 6 to 10 are views corresponding to FIGS. 1 to 5 showing a variant;

FIGS. 11 to 15 are views corresponding to FIGS. 1 to 5 showing a further variant; and

FIGS. 16 to 20 are views corresponding to FIGS. 1 to 5 showing a yet further variant.

### DESCRIPTION OF THE PREFERRED EMBODIMENTS

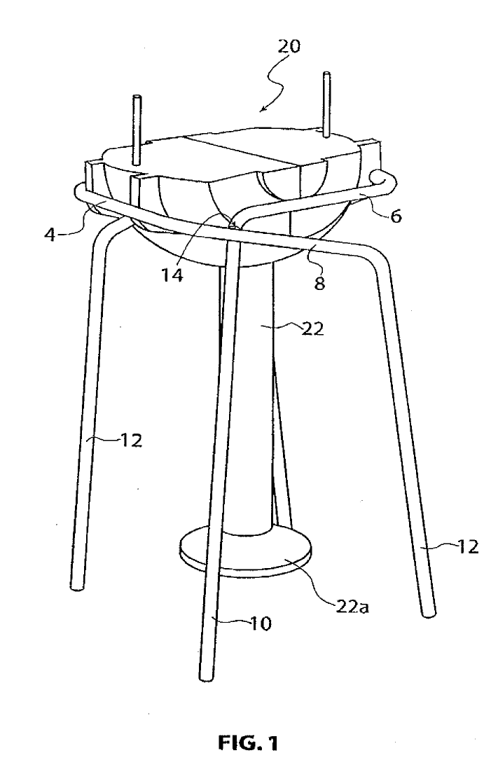

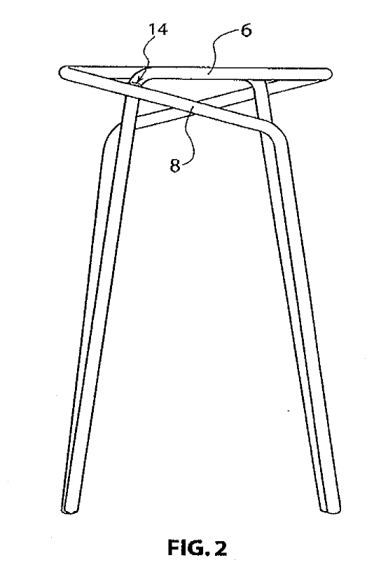

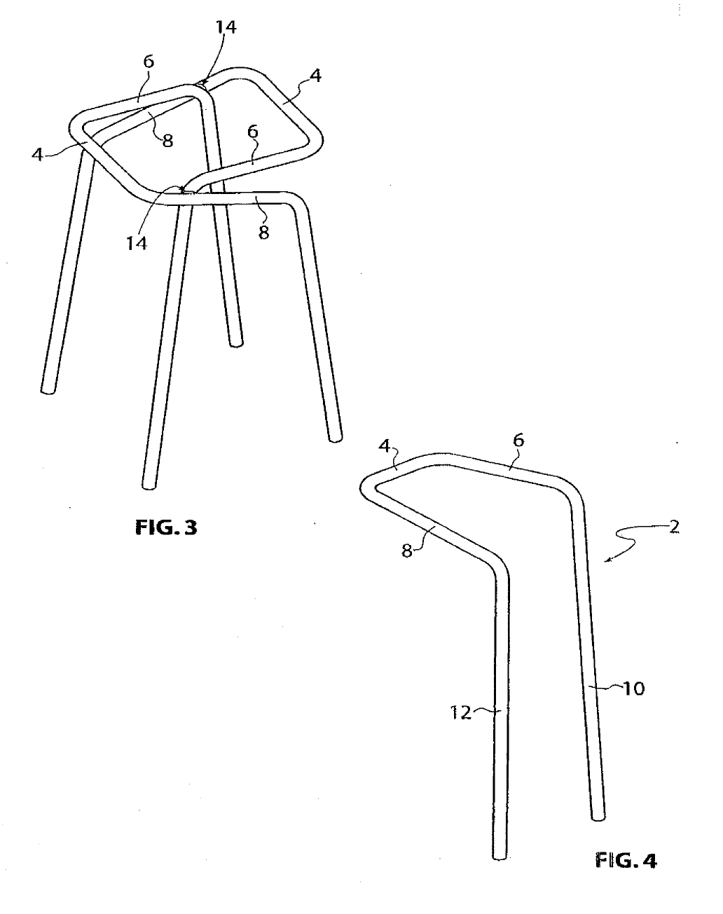

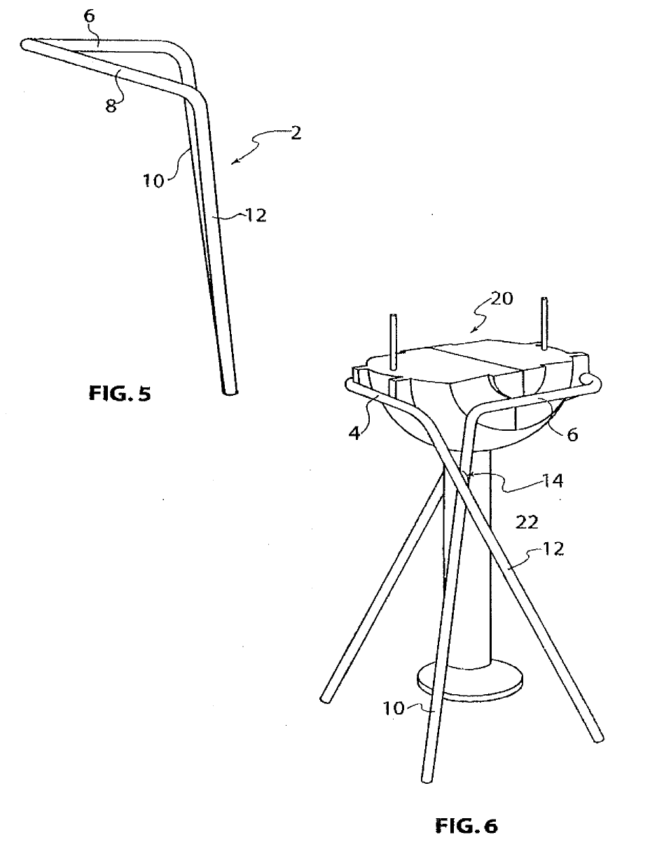

The support stand shown in FIGS. 1 to 5 consists of two identical components 2 each shaped by bending from a single piece of wire as shown in FIGS. 4 and 5. This provides at the upper end a central horizontal support bar 4 with a lateral bar 6, 8 extending from each end of the support bar 4 and then extending downwardly to form a leg 10, 12. It will be seen that the lateral bar 6 extends substantially horizontally from the support bar 4 whereas the bar 8 is somewhat inclined and this is readily visible in the side view of FIG. 5. The two components 2 are assembled in intersecting relationship as shown in FIG. 3 and are welded together at their two zones of intersection designated 14. In the assembled condition the central bars 4 and horizontal lateral bars 6 of the two components 2 cooperate to define a generally rectangular frame with horizontal sides into which the void former 20 can engage and be supported as shown in FIG. 1. In this condition, the head of the lifting anchor 22 is releasably locked within the void former 20 so that, effectively, the anchor 22 is suspended from the void former 20, with its foot portion 22a above the level of the casting bed on which the stand rests.

Accordingly in this embodiment the support stand is fabricated from two identical wire components each bent to required shape, in this particular case with four bends per component, with just two welds being needed to connect the components.

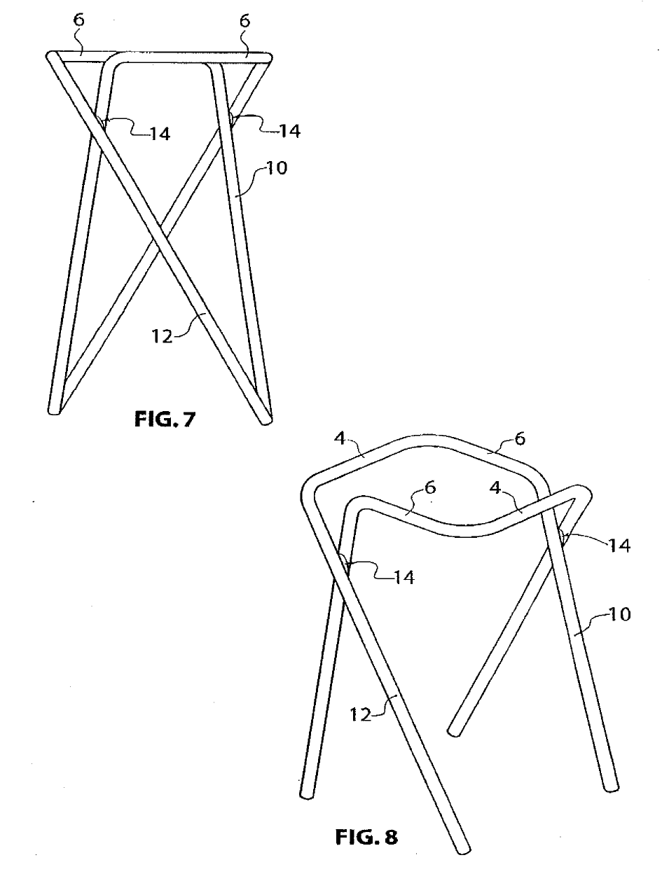

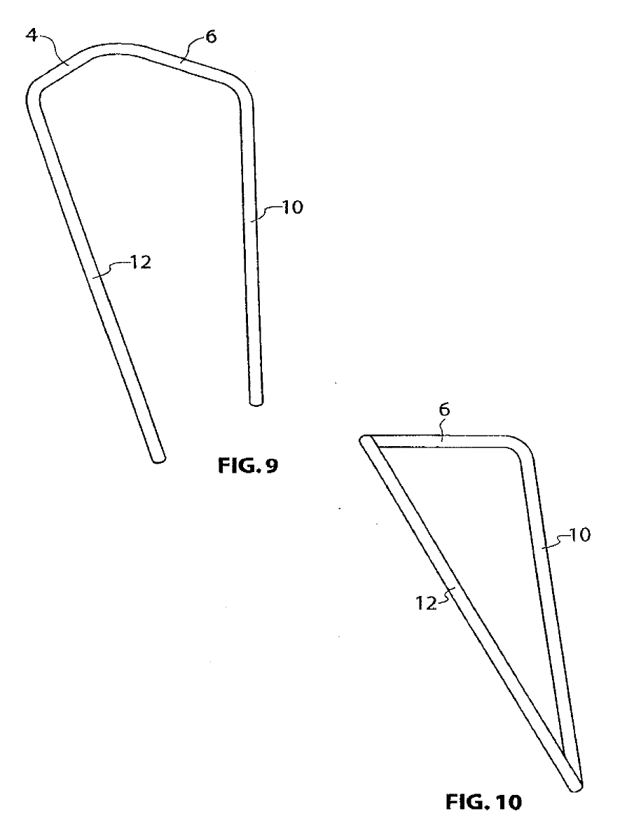

In the variant shown in FIGS. 6 to 10, the shaping of the upper part of each component 2 is changed somewhat, mainly by the elimination of the lateral bar 8, to permit the generally rectangular supporting frame defined in the assembled structure to be formed with only three bends per component.

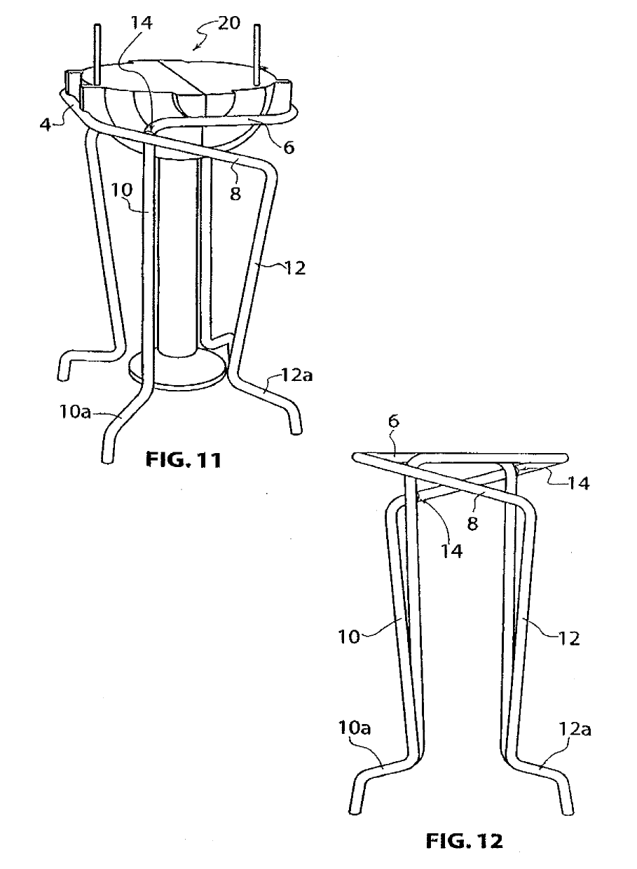

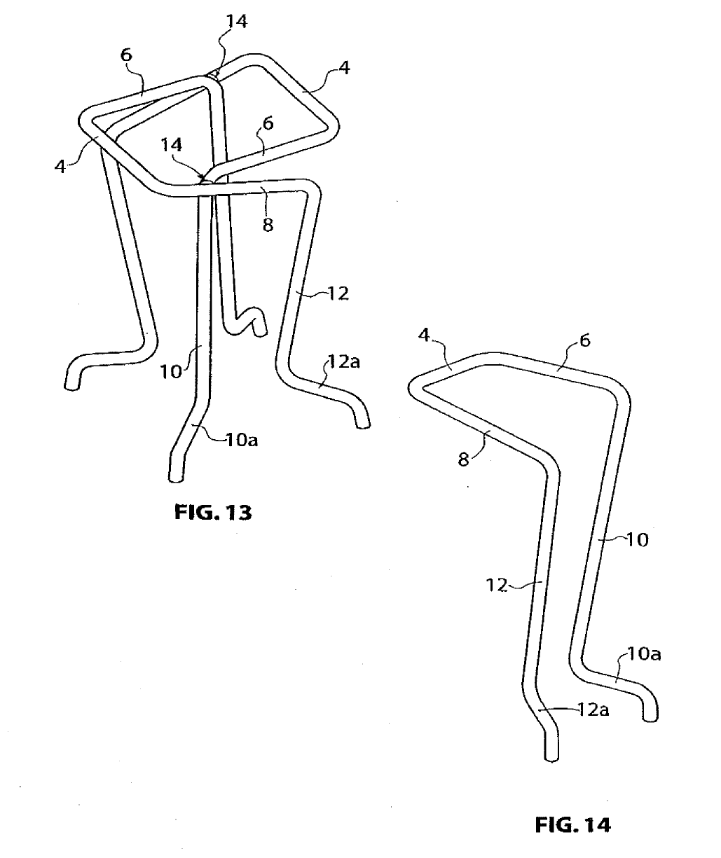

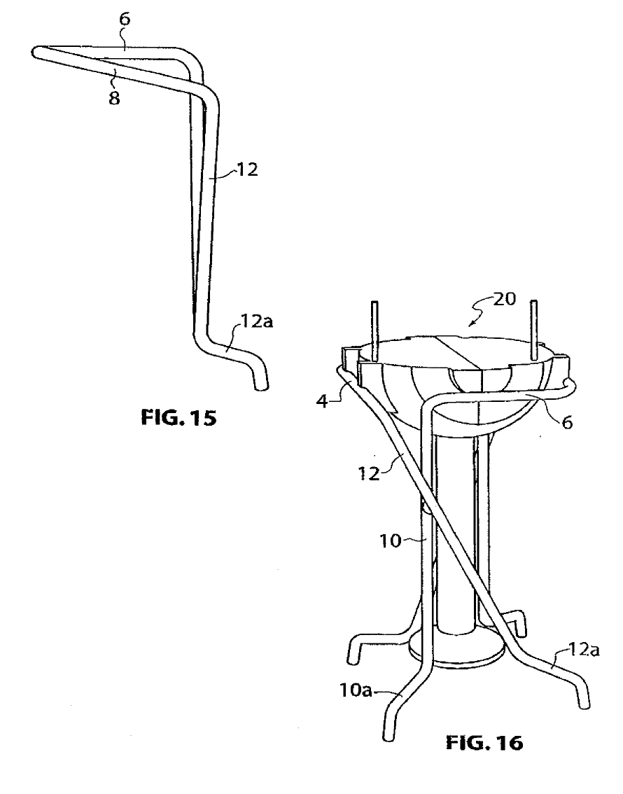

FIGS. 11 to 15 show a variation to the version shown in FIGS. 1 to 5 in which the legs 10, 12 are initially splayed inwardly and at their outer ends are bent outwardly and downwardly to define foot portions 10a, 12a. Although each component requires more bends than that used in the version of FIGS. 1 to 5 (eight bends rather than four) nevertheless this form may be desirable in some situations to facilitate improved cooperation with the reinforcement which is laid prior to casting.

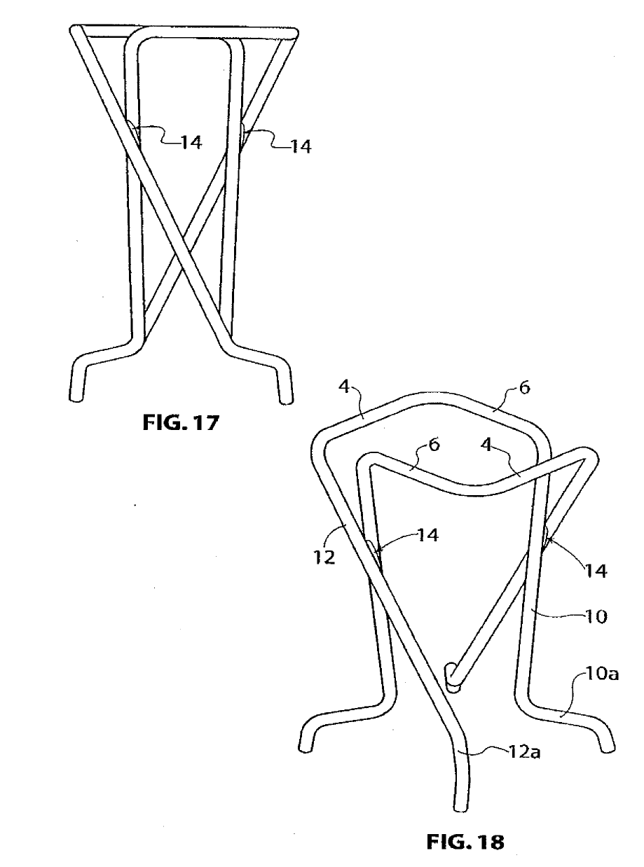

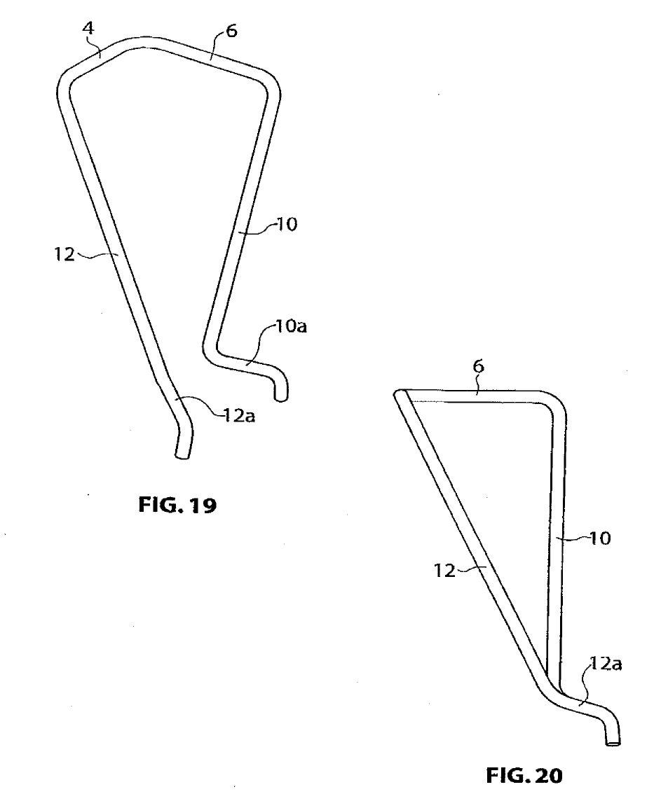

FIGS. 16 to 20 show a similar variant of the version of FIGS. 6 to 10 in which the legs 10, 12 have a reduced outwards splay and at their lower end portions are then bent outwardly and downwardly to define foot portions 10a, 12a. In this version seven bends per component are required.

In each of the embodiments described herein the support stand is assembled from just two identical components with only two welds being required, thereby simplifying and reducing the cost of the assembly.

The embodiments have been described by way of example only and modifications are possible within the scope of the invention.

1. A support stand for a void former and lifting anchor assembly to be cast into a concrete component, the support stand being formed from two components of bent wire which, when assembled together, define an upper frame from which the void former call be supported with the body of the anchor being suspended beneath the void former and legs projecting downwardly from the frame to rest on a bed on which the component is cast.

2. A support stand according to claim 1, wherein the two wire components are connected by only two welds, each at one of two zones of intersection of the two components.

3. A support stand according to claim 2, wherein the two components are of identical shape.

4. A support stand according to claim 3, wherein the upper frame is of generally rectangular shape and extends substantially horizontally.

5. A support stand according to claim 4, wherein each component provides one side of the frame and at least a substantial part of a further side extending from an end of the said one side transversely thereto.

6. A support stand according to claim 5, wherein each component provides two legs each directed downwardly from a respective end of the part thereof forming the upper frame.

7. A support stand according to claim 4, wherein the components intersect at zones closely adjacent to the parts thereof forming the upper frame.

8. A support stand according to claim 4, wherein the components intersect at the parts thereof forming the legs.

9. A support stand according to claim 4, wherein the lower end portions of the legs are bent outwardly and downwardly to form foot portions.

10. A support stand for an anchor to be cast into a concrete component, the support stand being formed from two identical components of bent wire welded together to form an open upper frame from which the anchor is supported and legs projecting downwardly from the frame to rest on a bed on which the concrete component is cast.
